(19) United States
(12) Patent Application Publication
(10) Pub. No.: US 2025/0220650 A1
(43) Pub. Date: Jul. 3, 2025

(54) RESOURCE DETERMINATION METHOD, APPARATUS, AND STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/850,468

(22) PCT Filed: Mar. 30, 2022
(86) PCT No.: PCT/CN2022/084194

§ 371 Date: Sep. 24, 2024

(51) Int. Cl. H04W 72/0453; H04L 5/00; H04W 72/232

(52) U.S. Cl. CPC H04W 72/0453; H04L 5/0053; H04W 72/232

(57) ABSTRACT

A method, apparatus and computer readable medium for resource determination in wireless communication. Uplink transmission resource allocation in scenarios involving simultaneous uplink and downlink transmission are addressed by determining frequency-domain resources occupied by an uplink subband based on a protocol. The determination is based on the resource blocks (RBs) of an uplink bandwidth part (BWP) in an uplink slot. A reference RB is used to identify the subband's location, ensuring that the number of RBs occupied by the uplink subband is consistent with those occupied by the uplink BWP.

### CROSS-REFERENCE TO RELATED APPLICATIONS

This application is a national stage of International Application No. PCT/CN2022/084194, filed on Mar. 30, 2022, which is hereby incorporated by reference in its entirety.

### TECHNICAL FIELD

The present disclosure relates to the communication field, and in particular, to a resource determination method and apparatus, and a storage medium.

### BACKGROUND

A full-duplex solution will be studied in the Release-18 duplex enhancement project, specifically, a network device can simultaneously transmit data and receive data within one slot.

Currently, 3GPP (3rd Generation Partnership Project) determines that the full-duplex enhancement of Rel-18 is only for gNB (base station), while a terminal side supports only half-duplex. The base station may configure an uplink (UL) subband for uplink data transmission in a downlink (DL) slot for an xDD (Division Duplex, full-duplex) terminal, and schedule uplink data transmission of the terminal in a time-frequency range of the UL subband.

However, there is no clear solution for determining the UL subband in the DL slot and schedule the uplink transmission in the DL slot.

### SUMMARY

To solve problems existing in related technologies, embodiments of the present disclosure provide a resource determination method and apparatus, and a storage medium.

According to a first aspect of the embodiments of the present disclosure, a resource determination method is provided, performed by a terminal, including:
determining, based on a protocol, a frequency-domain resource occupied by an uplink subband used for uplink transmission in a specified downlink slot, where the specified downlink slot is used for simultaneous uplink transmission and downlink transmission.

Optionally, the protocol indicates to determine resource blocks (RBs) occupied by the uplink subband based on RBs occupied by an uplink bandwidth part (BWP) in an uplink slot;
determining, based on the protocol, the frequency-domain resource occupied by the uplink subband used for uplink transmission in the specified downlink slot includes:
determining that the RBs occupied by the uplink subband is same as the RBs occupied by the uplink BWP.

Optionally, the protocol indicates to determine a number of resource blocks (RBs) occupied by the uplink subband based on a number of RBs occupied by an uplink bandwidth part (BWP) in an uplink slot, and to determine RBs occupied by the uplink subband based on a reference RB;
determining, based on the protocol, the frequency-domain resource occupied by the uplink subband used for uplink transmission in the specified downlink slot includes:
determining that the uplink subband includes a specified number of consecutive RBs with the reference RB being a start RB or an end RB; where the specified number is same as the number of RBs occupied by the uplink BWP.

Optionally, the reference RB includes:
an RB with a minimum index value or a maximum index value in RBs occupied by a downlink BWP; or,
an RB with a minimum index value in RBs occupied by a first control resource set (CORESET) for transmitting downlink control information (DCI); where a number of the first CORESET is one or more; or,
an RB with a minimum index value in RBs occupied by a second CORESET for transmitting a common search space (CSS).

Optionally, the first CORESET is a CORESET used for physical downlink control channel (PDCCH) transmission in the specified downlink slot, or the first CORESET is a CORESET used for PDCCH transmission in another downlink slot;
the second CORESET is a CORESET used for PDCCH transmission in the specified downlink slot, or the second CORESET is a CORESET used for PDCCH transmission in another downlink slot.

Optionally, the uplink BWP belongs to an activated BWP.

Optionally, the RBs occupied by the uplink subband is located in a range of RBs occupied by an activated downlink BWP; or
the RBs occupied by the uplink subband includes at least one RB located outside a range of RBs occupied by an activated downlink BWP.

Optionally, the method further includes at least one of:
determining RBs occupied by a physical uplink shared channel (PUSCH) in the frequency-domain resource occupied by the uplink subband based on information in a frequency-domain resource allocation information field included in received downlink control information (DCI);
determining RBs occupied by a PUSCH in the frequency-domain resource occupied by the uplink subband based on first resource indication information included in received first radio resource control (RRC) signaling; or
determining RBs occupied by a physical uplink control channel (PUCCH) and an uplink reference signal respectively in the frequency-domain resource occupied by the uplink subband based on second resource indication information included in received second RRC signaling.

According to a second aspect of the embodiments of the present disclosure, a resource determination method is provided, performed by a base station, including:
determining, based on a protocol, a frequency-domain resource occupied by an uplink subband used for uplink transmission in a specified downlink slot, where the specified downlink slot is used for simultaneous uplink transmission and downlink transmission.

Optionally, the protocol indicates to determine resource blocks (RBs) occupied by the uplink subband based on RBs occupied by an uplink bandwidth part (BWP) in an uplink slot;
determining, based on the protocol, the frequency-domain resource occupied by the uplink subband used for uplink transmission in the specified downlink slot includes:
determining that the RBs occupied by the uplink subband is same as the RBs occupied by the uplink BWP.

Optionally, the protocol indicates to determine a number of resource blocks (RBs) occupied by the uplink subband based on a number of RBs occupied by an uplink bandwidth part (BWP) in an uplink slot, and to determine RBs occupied by the uplink subband based on a reference RB;
determining, based on the protocol, the frequency-domain resource occupied by the uplink subband used for uplink transmission in the specified downlink slot includes:
determining that the uplink subband includes a specified number of consecutive RBs with the reference RB being a start RB or an end RB; where the specified number is same as the number of RBs occupied by the uplink BWP.

Optionally, the reference RB includes:
an RB with a minimum index value or a maximum index value in RBs occupied by a downlink BWP; or,
an RB with a minimum index value in RBs occupied by a first control resource set (CORESET) for transmitting downlink control information (DCI); where a number of the first CORESET is one or more; or,
an RB with a minimum index value in RBs occupied by a second CORESET for transmitting a common search space (CSS).

Optionally, the first CORESET is a CORESET used for physical downlink control channel (PDCCH) transmission in the specified downlink slot, or the first CORESET is a CORESET used for PDCCH transmission in another downlink slot;
the second CORESET is a CORESET used for PDCCH transmission in the specified downlink slot, or the second CORESET is a CORESET used for PDCCH transmission in another downlink slot.

Optionally, the uplink BWP belongs to an activated BWP.

Optionally, the RBs occupied by the uplink subband is located in a range of RBs occupied by an activated downlink BWP; or
the RBs occupied by the uplink subband includes at least one RB located outside a range of RBs occupied by an activated downlink BWP.

Optionally, the method further includes at least one of:
sending downlink control information (DCI) to a terminal; where a frequency-domain resource allocation information field is used by the terminal to determine RBs occupied by a physical uplink shared channel (PUSCH) in the frequency-domain resource occupied by the uplink subband;
sending first radio resource control (RRC) signaling including first resource indication information to the terminal; where the first resource indication information is used by the terminal to determine RBs occupied by the PUSCH in the frequency-domain resource occupied by the uplink subband; or
sending second RRC signaling including second resource indication information to the terminal; where the terminal uses the second resource indication information to determine RBs occupied by a physical uplink control channel (PUCCH) and an uplink reference signal respectively in the frequency-domain resource occupied by the uplink subband.

According to a third aspect of the embodiments of the present disclosure, a resource determination apparatus is provided, applied to a terminal, including:
a first determining module, configured to determine, based on a protocol, a frequency-domain resource occupied by an uplink subband used for uplink transmission in a specified downlink slot, where the specified downlink slot is used for simultaneous uplink transmission and downlink transmission.

According to a fourth aspect of the embodiments of the present disclosure, a resource determination apparatus is provided, applied to a base station, including:
a second determining module, configured to determine, based on a protocol, a frequency-domain resource occupied by an uplink subband used for uplink transmission in a specified downlink slot, where the specified downlink slot is used for simultaneous uplink transmission and downlink transmission.

According to a fifth aspect of the embodiments of the present disclosure, a computer-readable storage medium is provided, the storage medium stores a computer program, and the computer program is used to perform the resource determination method according to any one of the first aspect.

According to a sixth aspect of the embodiments of the present disclosure, a computer-readable storage medium is provided, the storage medium stores a computer program, and the computer program is used to perform the resource determination method according to any one of the second aspect.

According to a seventh aspect of the embodiments of the present disclosure, a resource determination device is provided, including:
a processor; and
a memory for storing a processor-executable instruction;
where the processor is configured to perform the resource determination method according to any one of the first aspect.

According to an eighth aspect of the embodiments of the present disclosure, a resource determination device is provided, including:
a processor; and
a memory for storing a processor-executable instruction;
where the processor is configured to perform the resource determination method according to any one of the second aspect.

The technical solutions provided by the embodiments of the present disclosure may include following beneficial effects.

The present disclosure can accurately determine the frequency-domain resource occupied by the uplink subband when a full-duplex terminal schedules or configures uplink transmission in the uplink subband in the downlink slot, thereby improving the feasibility of full-duplex communication.

It should be understood that the above general description and the following detailed description are only examples and illustrative, and do not limit the present disclosure.

### BRIEF DESCRIPTION OF DRAWINGS

The accompanying drawings, which are incorporated in and constitute a part of this specification, illustrate embodiments consistent with the present disclosure, and together with the description serve to explain the principles of the present disclosure.

FIG. 1 is a schematic diagram showing alignment of central frequency points of an uplink BWP and a downlink BWP according to an example embodiment.

FIG. 2 is a schematic flowchart of a resource determination method according to an example embodiment.

FIG. 3 is a schematic flowchart of another resource determination method according to an example embodiment.

FIG. 4 is a schematic flowchart of another resource determination method according to an example embodiment.

FIG. 5 is a schematic flowchart of another resource determination method according to an example embodiment.

FIG. 6A to FIG. 6C are schematic diagrams showing frequency-domain resources of DL transmission and UL transmission according to an example embodiment.

FIG. 7 is another schematic diagram showing alignment of frequency center points of an uplink BWP and a downlink BWP according to an example embodiment.

FIG. 8 is a schematic diagram of a scenario of resource determination according to an example embodiment.

FIG. 9 is a schematic diagram of a scenario of determining RBs occupied by a PUSCH according to an example embodiment.

FIG. 10 is a schematic diagram of another scenario of resource determination according to an example embodiment.

FIG. 11 is a schematic diagram of another scenario of determining RBs occupied by a PUSCH according to an example embodiment.

FIG. 12 is a schematic diagram of another scenario of resource determination according to an example embodiment.

FIG. 13 is a schematic diagram of another scenario of determining RBs occupied by a PUSCH according to an example embodiment.

FIG. 14 is a schematic diagram of another scenario of resource determination according to an example embodiment.

FIG. 15 is a schematic diagram of another scenario of resource determination according to an example embodiment.

FIG. 16 is a block diagram of a resource determination apparatus according to an example embodiment.

FIG. 17 is a block diagram of another resource determination apparatus according to an example embodiment.

FIG. 18 is a schematic structural diagram of a resource determination device according to an example embodiment of the present disclosure.

FIG. 19 is a schematic structural diagram of another resource determination device according to an example embodiment of the present disclosure.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the present disclosure. Rather, they are merely examples of apparatuses and methods consistent with some aspects of the present disclosure as detailed in the appended claims.

The terminology used in the present disclosure is for the purpose of describing particular embodiments only and is not intended to limit the present disclosure. The singular forms “a/an “the and “said” used in the present disclosure and the appended claims are also intended to include plural forms unless the context clearly indicates other meanings. It should also be understood that the term “and/or” as used herein refers to and includes any or all possible combinations of at least one associated listed item.

It should be understood that although the terms “first “second “third etc., may be used in the present disclosure to describe various information, these information should not be limited to these terms. These terms are only used to distinguish a same type of information from each other. For example, “first information” may also be referred to as “second information” without departing from the scope of the present disclosure, and similarly, the “second information” may also be referred to as “first information”. Depending on context, the word “if”' as used herein may be interpreted as “when” or “upon” or “in response to determining”.

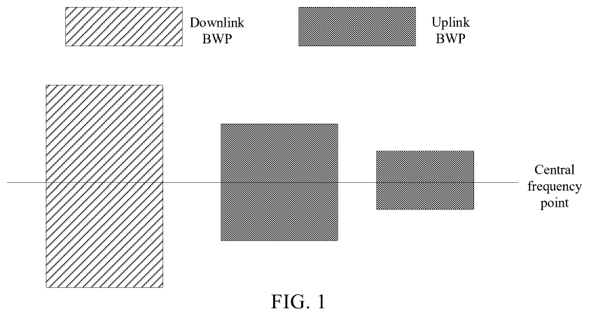

In a new radio (NR) system, central frequency points of a UL (Uplink) BWP (Bandwidth Part) and a DL (Downlink) BWP in an unpaired spectrum need to be aligned, but the UL BWP and the DL BWP may be configured with frequency-domain resources of different sizes, for example, as shown in FIG. 1.

In a conventional protocol, the UL BWP can only be configured in a UL slot. That is, there is no UL BWP configuration in a DL slot, and there is no clear solution for determining frequency-domain resources available for uplink transmission in the DL slot.

In addition, the base station generally indicates a frequency-domain resource occupied by uplink data channel transmission through downlink control information (DCI), and indicates a frequency-domain resource occupied by the UL BWP through a specified information field in the DCI.

When the base station configures a transmission type of “Type1 configured grant a frequency-domain resource occupied by PUSCH (Physical Uplink Shared Channel) transmission needs to be configured in the UL BWP.

For other types of uplink transmission, such as a PUCCH (Physical Uplink Control Channel) or an SRS (Sounding Reference Signal), a transmission resource thereof also needs to be configured within a range of the UL BWP.

Since the DL BWP and the UL BWP may not be aligned in frequency-domain, when an uplink channel transmitted in a DL slot is indicated by using a specified information field in DCI, a start position of the frequency-domain resource to be covered as indicated by the frequency domain needs to be determined. However, there is no clear solution for determining the start position of the uplink frequency-domain resource.

To resolve the above technical problems, the present disclosure provides a resource determination method in the following. The resource determination method provided by the present disclosure will be described from a terminal side first.

An embodiment of the present disclosure provides a resource determination method, as shown in FIG. 2, FIG. 2 is a flowchart of a resource determination method according to an embodiment, where the method may be performed by a terminal and may include following steps.

In step 201, determining, based on a protocol, a frequency-domain resource occupied by an uplink subband used for uplink transmission in a specified downlink slot.

In an embodiment of the present disclosure, the specified downlink slot is used for simultaneous uplink transmission and downlink transmission.

In the above embodiment, the terminal can accurately determine, based on the protocol, the frequency-domain resource occupied by the uplink subband in the specified downlink slot, thereby improving feasibility of full-duplex communication.

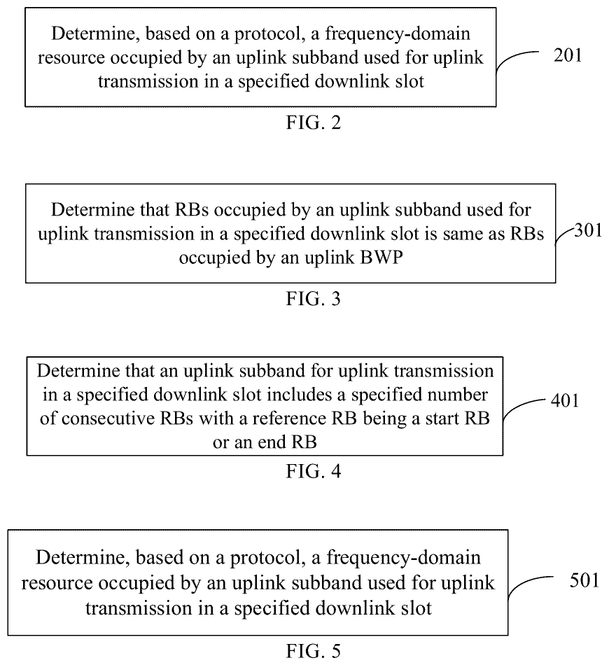

In some optional embodiments, the protocol indicates to determine resource blocks (RBs) occupied by the uplink subband based on RBs occupied by an uplink BWP in an uplink slot. Correspondingly, as shown in FIG. 3, FIG. 3 is a flowchart of a resource determination method according to an embodiment, where the method may be performed by a terminal and may include following steps.

Step 301: determining that RBs occupied by an uplink subband used for uplink transmission in a specified downlink slot is same as RBs occupied by an uplink BWP.

In an embodiment of the present disclosure, the specified downlink slot is used for simultaneous uplink transmission and downlink transmission. The RBs occupied by the uplink subband in the specified downlink slot being same as the RBs occupied by the uplink BWP refers to that central frequency points are aligned and RB indexes are same. The uplink BWP belongs to an activated BWP.

In the above embodiment, the terminal may determine that the RBs occupied by the uplink subband used for uplink transmission in the specified downlink slot is completely same as the RBs occupied by the activated uplink BWP. A purpose of accurately determining the frequency-domain resource occupied by the uplink subband in the specified downlink slot is achieved, and the feasibility of full-duplex communication is improved.

In some optional embodiments, the protocol indicates to determine a number of resource blocks (RBs) occupied by the uplink subband based on a number of RBs occupied by an uplink bandwidth part (BWP) in an uplink slot, and to determine RBs occupied by the uplink subband based on a reference RB. Correspondingly, as shown in FIG. 4, FIG. 4 is a flowchart of a resource determination method according to an embodiment, where the method may be performed by a terminal and may include following steps.

In step 401, determining that an uplink subband for uplink transmission in a specified downlink slot includes a specified number of consecutive RBs with a reference RB being a start RB or an end RB.

In an embodiment of the present disclosure, the specified downlink slot is used for simultaneous uplink transmission and downlink transmission, and the specified number is same as the number of RBs occupied by the uplink BWP. The uplink BWP belongs to an activated BWP.

In the above embodiment, the terminal can determine that the uplink subband includes a specified number of consecutive RBs with a reference RB as a start RB or an end RB, and the specified number is same as the number of RBs included in the activated uplink BWP, which also achieves accurate determination of the frequency-domain resource occupied by the uplink subband in the specified downlink slot, thereby improving feasibility of full-duplex communication.

In some optional embodiments, the reference RB includes: an RB with a minimum index value or a maximum index value in RBs occupied by a downlink BWP. Optionally, the downlink BWP belongs to an activated BWP.

The uplink subband used for uplink transmission in the specified downlink slot includes the specified number of consecutive RBs with a start RB or an end RB being the RB with the minimum index value or the maximum index value in the RBs occupied by the downlink BWP. The specified number is same as the number of RBs included in the uplink BWP. The uplink BWP belongs to an activated BWP.

For example, the activated uplink BWP occupies a number L of RBs, and the uplink subband includes L consecutive RBs with the start RB or the end RB being the RB with the minimum index value or the maximum index value in the RBs occupied by the downlink BWP.

In the above embodiment, the terminal can determine that the uplink subband includes consecutive RBs with the start RB or the end RB being the RB with the maximum index value or the minimum index value in the RBs occupied by the downlink BWP. A purpose of accurately determining the frequency-domain resource occupied by the uplink subband in the specified downlink slot is achieved, and the feasibility of full-duplex communication is improved.

In some optional embodiments, the reference RB includes an RB with a minimum index value or a maximum index value in RBs occupied by a first control resource set (CORESET) for transmitting downlink control information (DCI).

The uplink subband used for uplink transmission in the specified downlink slot includes the specified number of consecutive RBs with the start RB or the end RB being the RB with the minimum (or maximum) index value in the RBs occupied by the first CORESET. The specified number is same as the number of RBs included in the uplink BWP. The uplink BWP belongs to an activated BWP.

In the embodiment of the present disclosure, there may be one or more first CORESETs, which is not limited in the present disclosure. If there are more than one first CORESETs, the uplink subband includes the specified number of consecutive RBs with the start RB or the end RB being an RB with a minimum (or maximum) index value in RBs occupied by the first CORESETs, or being an adjacent RB of the RB with the minimum (or maximum) index value in the RBs occupied by the first CORESETs.

For example, a minimum index value of the RBs occupied by the first CORESET is C, and the activated uplink BWP occupies a number L of RBs, and the uplink subband includes a number C to C+L RBs, or includes a number C−L−1 to C−1 of RBs.

In a possible implementation, the first CORESET is a CORESET used for physical downlink control channel (PDCCH) transmission in the specified downlink slot.

In a possible implementation, the first CORESET is a CORESET used for PDCCH transmission in another downlink slot.

In the above embodiment, a purpose of accurately determining the frequency-domain resource occupied by the uplink subband in the specified downlink slot is achieved, and the feasibility of full-duplex communication is improved.

In some optional embodiments, the reference RB includes an RB with a minimum (or maximum) index value in RBs occupied by a second CORESET for transmitting a common search space (CSS).

The uplink subband for uplink transmission in the specified downlink slot includes a specified number of consecutive RBs with a start RB or an end RB being an RB with a minimum (or maximum) index value in the RBs occupied by the second CORESET. The specified number is same as the number of RBs included in the uplink BWP. The uplink BWP belongs to an activated BWP.

In the embodiment of the present disclosure, there may also be one or more second CORESETs, which is not limited in the present disclosure. If there are more than one second CORESETs, the uplink subband includes the specified number of consecutive RBs with the start RB or the end RB being an RB with a minimum (or maximum) index value in the RBs occupied by the second CORESETs, or being an adjacent RB of the RB with the minimum (or maximum) index value in the RBs occupied by the second CORESETs.

For example, a minimum index value of the RBs occupied by the second CORESET is C, and the activated uplink BWP occupies a number L of RBs, and the uplink subband includes a number C to C+L RBs, or includes a number C−L−1 to C−1 of RBs.

In a possible implementation, the second CORESET is a CORESET used for physical downlink control channel (PDCCH) transmission in the specified downlink slot.

In another possible implementation, the second CORESET is a CORESET used for PDCCH transmission in another downlink slot.

In the above embodiment, a purpose of accurately determining the frequency-domain resource occupied by the uplink subband in the specified downlink slot is achieved, and feasibility of full-duplex communication is improved.

In the above embodiment, all uplink BWPs belong to activated BWPs.

In some optional embodiments, the RBs occupied by the uplink subband is located in a range of RBs occupied by an activated downlink BWP, that is, the frequency-domain resource included in the uplink subband is limited within a range of frequency-domain resources occupied by the activated downlink BWP.

Alternatively, the RBs occupied by the uplink subband includes at least one RB located outside a range of RBs occupied by an activated downlink BWP, that is, the frequency-domain resource included in the uplink subband is not limited within the range of frequency-domain resources occupied by the activated downlink BWP.

In some optional embodiments, the terminal determines RBs occupied by a physical uplink shared channel (PUSCH) in the frequency-domain resource occupied by the uplink subband based on information in a frequency-domain resource allocation (FDRA) information field included in received DCI.

The terminal determines RBs occupied by a PUSCH in the frequency-domain resource occupied by the uplink subband based on first resource indication information included in received first RRC signaling.

The terminal determines RBs occupied by a PUCCH and an uplink reference signal respectively in the frequency-domain resource occupied by the uplink subband based on second resource indication information included in received second RRC signaling.

In the above embodiment, after determining the frequency-domain resource occupied by the uplink subband, the terminal may determine, based on DCI or RRC signaling sent by the base station, the resource occupied by the uplink channel and/or the uplink signal, which is easy to be implemented and has high applicability.

The resource determination method provided by the present disclosure will then be described from a base station side.

An embodiment of the present disclosure provides a resource determination method, referring to FIG. 5, FIG. 5 is a flowchart of a resource determination method according to an embodiment, where the method may be performed by a base station and may include following steps.

In step 501, determining, based on a protocol, a frequency-domain resource occupied by an uplink subband used for uplink transmission in a specified downlink slot.

In the embodiment of the present disclosure, the specified downlink slot is used for simultaneous uplink transmission and downlink transmission.

In the above embodiment, the base station can accurately determine, based on the protocol, the frequency-domain resource occupied by the uplink subband in the specified downlink slot, thereby improving feasibility of full-duplex communication. In addition, it may be ensured that the frequency-domain resource occupied by the uplink subband are determined by the base station and the terminal in a same manner, thereby avoiding a problem of inconsistent understanding of the frequency-domain resource occupied by the uplink subband by the base station and the terminal.

In some optional embodiments, the base station may determine the frequency-domain resource in any one of following manners.

Manner 1, the protocol indicates to determine RBs occupied by the uplink subband based on RBs occupied by an uplink BWP in an uplink slot.

The base station determines that the RBs occupied by the uplink subband is same as the RBs occupied by the uplink BWP.

Manner 2, the protocol indicates to determine a number of resource blocks (RBs) occupied by the uplink subband based on a number of RBs occupied by an uplink bandwidth part (BWP) in an uplink slot, and to determine RBs occupied by the uplink subband based on a reference RB. The reference RB includes: an RB with a minimum index value or a maximum index value in RBs occupied by a downlink BWP.

The base station determines that the uplink subband includes a specified number of consecutive RBs with the reference RB being a start RB or an end RB; where the specified number is same as the number of RBs occupied by the uplink BWP.

Manner 3, the protocol indicates to determine a number of RBs occupied by the uplink subband based on a number of RBs occupied by an uplink BWP in an uplink slot, and to determine RBs occupied by the uplink subband based on a reference RB. The reference RB includes an RB with a minimum (or maximum) index value in RBs occupied by a first control resource set (CORESET) for transmitting downlink control information (DCI). There is one or more first CORESETs.

The base station determines that the uplink subband includes a specified number of consecutive RBs with the reference RB as a start RB or an end RB. The specified number is same as the number of RBs included in the uplink BWP.

Manner 4, the protocol indicates to determine a number of RBs occupied by the uplink subband based on a number of RBs occupied by an uplink BWP in an uplink slot, and to determine RBs occupied by the uplink subband based on a reference RB. The reference RB includes an RB with a minimum (or maximum) index value in RBs occupied by a second CORESET for transmitting a common search space (CSS).

The base station determines that the uplink subband includes a specified number of consecutive RBs with the reference RB as a start RB or an end RB. The specified number is same as the number of RBs included in the uplink BWP.

A specific implementation manner is similar to the determining manner of the terminal side, and details will not be repeated herein.

In some optional embodiments, the uplink BWP belong to an activated BWP.

In some optional embodiments, the RBs occupied by the uplink subband is located in a range of RBs occupied by an activated downlink BWP; or the RBs occupied by the uplink subband includes at least one RB located outside a range of RBs occupied by an activated downlink BWP.

In some optional embodiments, the base station may send DCI to a terminal; where a frequency-domain resource allocation information field is used by the terminal to determine an RBs occupied by a physical uplink shared channel (PUSCH) in the frequency-domain resource occupied by the uplink subband.

The base station may also send first RRC signaling including first resource indication information to the terminal; where the first resource indication information is used by the terminal to determine RBs occupied by the PUSCH in the frequency-domain resource occupied by the uplink subband.

The base station may also send second RRC signaling including second resource indication information to the terminal; where the second resource indication information is used by the terminal to determine RBs occupied by a physical uplink control channel (PUCCH) and an uplink reference signal respectively in the frequency-domain resource occupied by the uplink subband.

In the above embodiment, the base station may notify the terminal, by using DCI or RRC signaling, of the frequency-domain resource occupied by an uplink channel and/or an uplink signal transmitted on the uplink subband in the specified downlink slot, which is easy to be implemented and has high applicability.

To facilitate understanding of the above method, the resource determination method provided in the present disclosure is further described with examples as follows.

Embodiment 1: assuming that the terminal is a terminal of Rel-18 and subsequent versions, and has a half-duplex capability or a full-duplex capability, which is not limited in the present disclosure. Assuming that the base station performs a full-duplex operation in a downlink slot of a time division duplex (TDD) frequency band, that is, schedules downlink data and uplink data simultaneously. When the base station performs the full-duplex operation, one of following manners is used, which is not limited in the present disclosure.

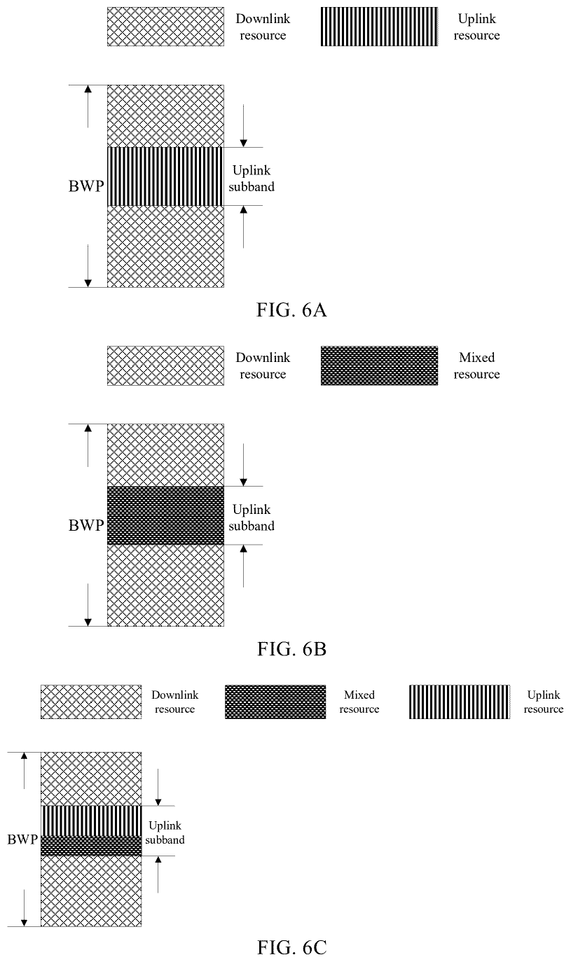

Frequency-domain resources used for DL transmission and UL transmission in the DL slot are independent and non-overlapped, for example, as shown in FIG. 6A.

Frequency-domain resources used for DL transmission and UL transmission in the DL slot are completely overlapped, for example, as shown in FIG. 6B.

Frequency-domain resources used for DL transmission and UL transmission in the DL slot are partially overlapped, for example, as shown in FIG. 6C.

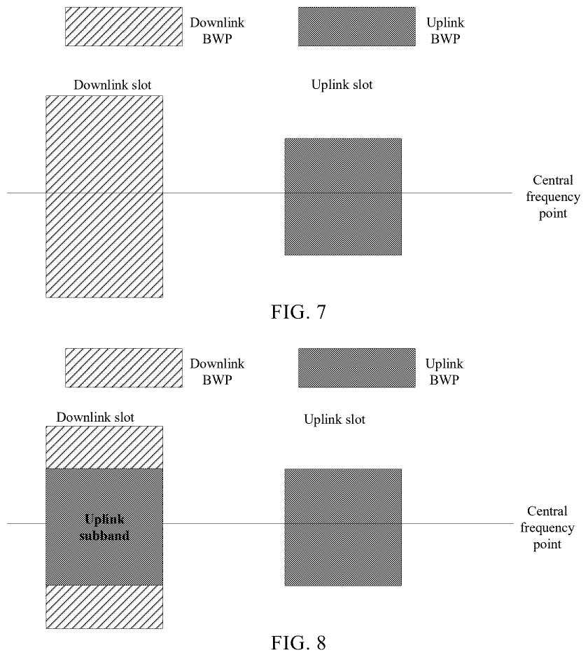

The TDD UL-DL configuration of a current system is assumed to be DDDDDDSUUU, and a bandwidth of a DL BWP in a DL slot is different from a bandwidth of a UL BWP in a UL slot. For a TDD frequency band, central frequency points of the DL BWP and the UL BWP need to be aligned, for example, as shown in FIG. 7.

When scheduling or configuring uplink transmission in the DL slot, the base station determines a frequency-domain resource being available for uplink transmission by using a following manner: RBs included in a UL subband in the DL slot being available for uplink transmission is same as RBs included in an UL BWP in a UL slot.

Based on this manner, in the DL slot, when the base station schedules a dynamic grant (DG) PUSCH through DCI, or configures a configure grant (CG) PUSCH through RRC signaling, or configures a PUCCH resource set through RRC signaling, or configures an SRS resource set through RRC signaling, the scheduling or configuring needs to be performed within an RB range occupied by the UL BWP, as shown in FIG. 8.

Specifically, taking the DG PUSCH as an example, the terminal receives DCI for uplink scheduling, for example, DCI format 0_0, DCI format 0_1 or DCI format 0_2, and the terminal determines, according to an FDRA field carried in the scheduling DCI, RBs occupied by the PUSCH within a frequency-domain range included in the UL subband determined by the above manner.

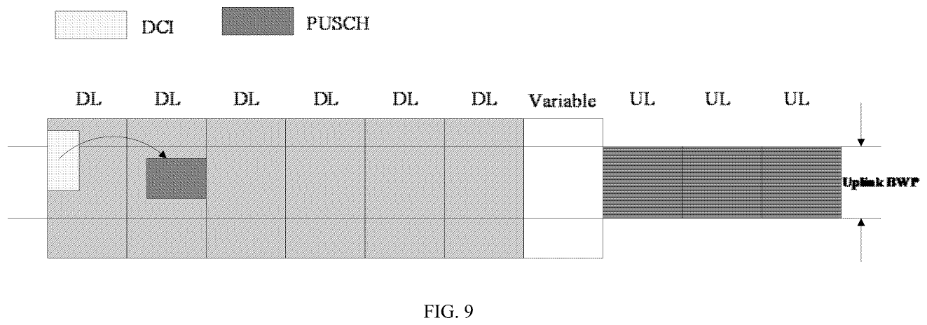

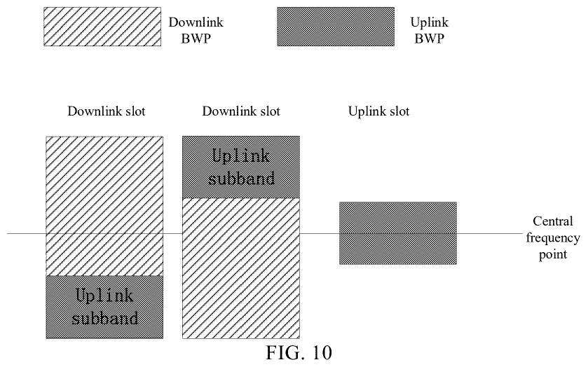

Further, referring to FIG. 9, the UL BWP used to determine the frequency-domain resource occupied by the UL subband in the DL slot is a currently activated UL BWP.

Embodiment 2: assuming that the terminal is a terminal of Rel-18 and subsequent versions, and has a half-duplex capability or a full-duplex capability, which is not limited in the present disclosure. Assuming that the base station performs a full-duplex operation in a downlink slot of a time division duplex (TDD) frequency band, that is, schedules downlink data and uplink data simultaneously. When the base station performs the full-duplex operation, one of following manners is used, which is not limited in the present disclosure.

Frequency-domain resources used for DL transmission and UL transmission in the DL slot are independent and non-overlapped, for example, as shown in FIG. 6A.

Frequency-domain resources used for DL transmission and UL transmission in the DL slot are completely overlapped, for example, as shown in FIG. 6B.

Frequency-domain resources used for DL transmission and UL transmission in the DL slot are partially overlapped, for example, as shown in FIG. 6C.

The TDD UL-DL configuration of a current system is assumed to be DDDDDDSUUU, and a bandwidth of a DL BWP in a DL slot is different from a bandwidth of a UL BWP in a UL slot. For a TDD frequency band, central frequency points of the DL BWP and the UL BWP need to be aligned, for example, as shown in FIG. 7.

When scheduling or configuring uplink transmission in the DL slot, the base station determines a frequency-domain resource being available for uplink transmission by using a following manner.

A number of RBs included in the UL subband for uplink transmission in the DL slot is same as a number of RBs included in the UL BWP in the UL slot, and the UL subband include a number L of consecutive RBs starting from an RB with minimum or maximum index value in the DL BWP, where L is the number of RBs occupied by the UL BWP.

This manner can be referred from FIG. 10. In the DL slot, when the base station schedules a DG PUSCH through DCI, or configures a CG PUSCH through RRC signaling, or configures a PUCCH resource set through RRC signaling, or configures an SRS resource set through RRC signaling, the scheduling or configuring needs to be performed within the RB range occupied by the UL BWP.

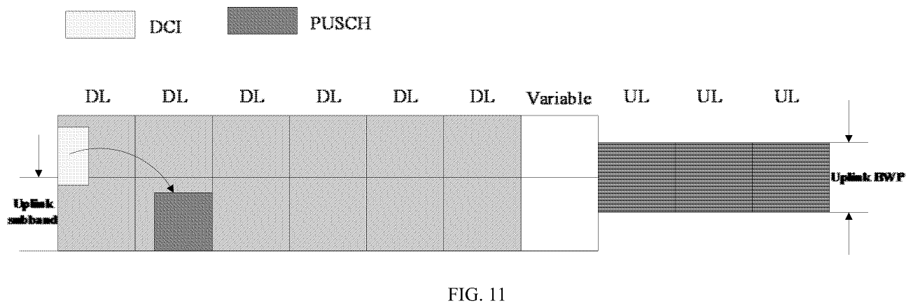

Specifically, taking the DG PUSCH as an example, the terminal receives DCI for uplink scheduling, for example, DCI format 0_0, DCI format 0_1 or DCI format 0_2, and the terminal determines, according to an FDRA field carried in the scheduling DCI, RBs occupied by the PUSCH within a frequency-domain range included in the UL subband determined by the above manner. Referring to FIG. 11, assuming that a resource range available for uplink transmission in the DL slot takes an RB with a minimum index value in the DL BWP as a reference RB.

Further, the UL BWP used to determine the frequency-domain resource occupied by the UL subband in the DL slot is a currently activated UL BWP.

Embodiment 3: assuming that the terminal is a terminal of Rel-18 and subsequent versions, and has a half-duplex capability or a full-duplex capability, which is not limited in the present disclosure. Assuming that the base station performs a full-duplex operation in a downlink slot of a time division duplex (TDD) frequency band, that is, schedules downlink data and uplink data simultaneously. When the base station performs the full-duplex operation, one of following manners is used, which is not limited in the present disclosure.

Frequency-domain resources used for DL transmission and UL transmission in the DL slot are independent and non-overlapped, for example, as shown in FIG. 6A.

Frequency-domain resources used for DL transmission and UL transmission in the DL slot are completely overlapped, for example, as shown in FIG. 6B.

Frequency-domain resources used for DL transmission and UL transmission in the DL slot are partially overlapped, for example, as shown in FIG. 6C.

The TDD UL-DL configuration of a current system is assumed to be DDDDDDSUUU, and a bandwidth of a DL BWP in a DL slot is different from a bandwidth of a UL BWP in a UL slot. For a TDD frequency band, central frequency points of the DL BWP and the UL BWP need to be aligned, for example, as shown in FIG. 7.

When scheduling or configuring uplink transmission in the DL slot, the base station determines a frequency-domain resource being available for uplink transmission by using a following manner.

A number of RBs included in the UL subband for uplink transmission in the DL slot is same as a number of RBs included in the UL BWP in the UL slot, the UL subband includes a number L of consecutive RBs by taking an RB with a minimum index value in the RBs occupied by a first CORESET for DCI transmission as a reference RB, where L is the number of RBs occupied by the UL BWP.

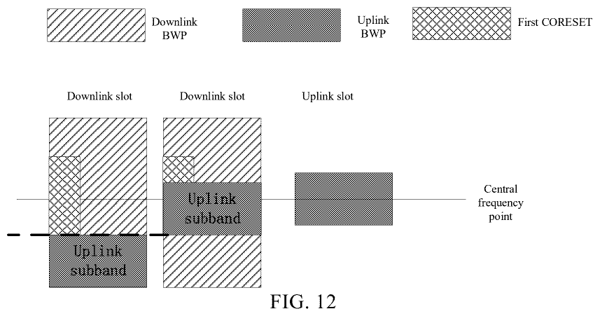

Based on this manner, in the DL slot, when the base station schedules a DG PUSCH through DCI, or configures a CG PUSCH through RRC signaling, or configures a PUCCH resource set through RRC signaling, or configures an SRS resource set through RRC signaling, the scheduling or configuring needs to be performed within the RB range occupied by the UL BWP. For example, as shown in FIG. 12, the UL subband includes a number C to C+L of RBs or a number of C−L−1 to C−1 RBs, where C is the minimum index value in the RBs occupied by the first CORESET.

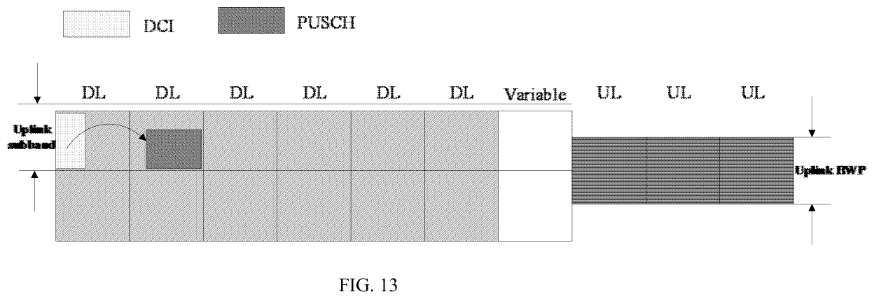

Specifically, taking the DG PUSCH as an example, the terminal receives DCI for uplink scheduling, for example, DCI format 0_0, DCI format 0_1 or DCI format 0_2, and the terminal determines, according to an FDRA field carried in the scheduling DCI, RBs occupied by the PUSCH within a frequency-domain range included in the UL subband determined by the above manner. Referring to FIG. 13, assuming that a resource range available for uplink transmission in the DL slot taking an RB with a minimum index value in the DL BWP as the reference RB.

Further, the UL BWP used to determine the frequency-domain resource occupied by the UL subband in the DL slot is a currently activated UL BWP.

Embodiment 4: as described in the embodiment 3, when the UL subband used for uplink transmission in the DL slot overlaps with a CORESET for transmitting a PDCCH, a terminal does not expect to detect and receive the PDCCH on the resource, and may transmit uplink data or an uplink signal on the resource according to scheduling information or configuration of the base station.

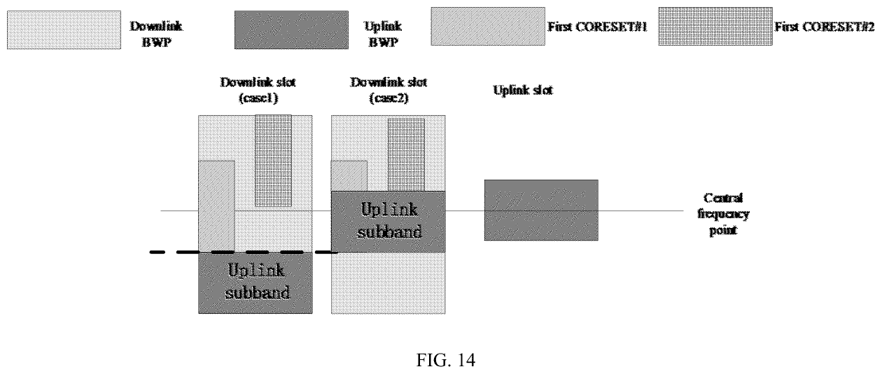

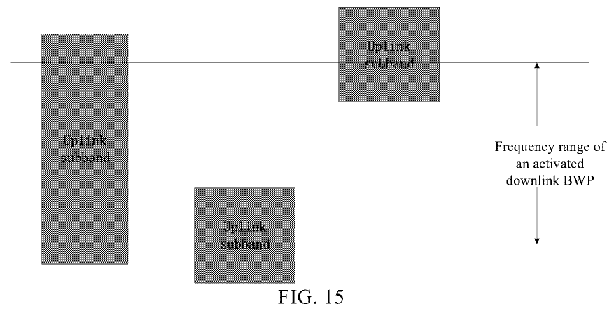

Embodiment 5: as described in the embodiment 3 or the embodiment 4, the base station configures N first CORESETs for the terminal, and in this case, an RB with a minimum index value in the plurality of first CORESETs is used as the reference RB. In this embodiment, assuming N=2, and assuming that the base station configures a first CORESET #1 and a first CORESET #2 for the terminal to perform PDCCH transmission, as shown in FIG. 14. In this embodiment, the base station and the terminal takes an RB with a minimum index value in the first CORESET #1 as the reference RB, so as to determine the RBs occupied by the uplink subband. Other specific manners are consistent with the embodiment 3 and the embodiment 4, and details will not be repeated herein.

Embodiment 6: assuming that the terminal is a terminal of Rel-18 and subsequent versions, and has a half-duplex capability or a full-duplex capability, which is not limited in the present disclosure. Assuming that the base station performs a full-duplex operation in a downlink slot of a time division duplex (TDD) frequency band, that is, schedules downlink data and uplink data simultaneously. When the base station performs the full-duplex operation, one of following manners is used, which is not limited in the present disclosure.

Frequency-domain resources used for DL transmission and UL transmission in the DL slot are independent and non-overlapped, for example, as shown in FIG. 6A.

Frequency-domain resources used for DL transmission and UL transmission in the DL slot are completely overlapped, for example, as shown in FIG. 6B.

Frequency-domain resources used for DL transmission and UL transmission in the DL slot are partially overlapped, for example, as shown in FIG. 6C.

The TDD UL-DL configuration of a current system is assumed to be DDDDDDSUUU, and a bandwidth of a DL BWP in a DL slot is different from a bandwidth of a UL BWP in a UL slot. For a TDD frequency band, central frequency points of the DL BWP and the UL BWP need to be aligned, for example, as shown in FIG. 7.

When scheduling or configuring uplink transmission in the DL slot, the base station determines a frequency-domain resource being available for uplink transmission by using a following manner.

A number of RBs included in the UL subband for uplink transmission in the DL slot is same as a number of RBs included in the UL BWP in the UL slot, the UL subband includes a number L of consecutive RBs starting from an RB with a minimum index value in the RBs occupied by a second CORESET for CSS (Common Search Space) transmission, where L is the number of RBs occupied by the UL BWP.

Based on this manner, in the DL slot, when the base station schedules a DG PUSCH through DCI, or configures a CG PUSCH through RRC signaling, or configures a PUCCH resource set through RRC signaling, or configures an SRS resource set through RRC signaling, the scheduling or configuring needs to be performed within the RB range occupied by the UL BWP.

Embodiment 7: the manner according to the embodiment 4 to the embodiment 6, when the start position of the frequency-domain resource of the UL subband in the specified downlink slot is determined according to the first CORESET or the second CORESET, the first CORESET or the second CORESET is a CORESET for PDCCH transmission in the specified downlink slot configured with the UL subband, or is a CORESET for PDCCH transmission in another downlink slot configured for the base station, which is not limited in the present disclosure.

Embodiment 8: the manner according to the embodiment 1 to the embodiment 7, the RB occupied by the uplink subband is located in a range of RBs occupied by an activated downlink BWP; or the RB occupied by the uplink subband includes at least one RB located outside a range of RBs occupied by an activated downlink BWP, as shown in FIG. 15. Certainly, defining of other uplink subbands are not limited in the present disclosure.

In the above embodiment, both the terminal and the base station can accurately determine, based on the protocol, the frequency-domain resource occupied by the uplink subband in the specified downlink slot, thereby improving feasibility of full-duplex communication. In addition, the problem of inconsistent understanding of the frequency-domain resource occupied by the uplink subband by the base station and the terminal can be avoided.

Corresponding to the above embodiments of the resource determination method, the present disclosure further provides embodiments of a resource determination apparatus.

Referring to FIG. 16, FIG. 16 is a block diagram of a resource determination apparatus according to an example embodiment. The apparatus is applied to a terminal, and includes:

a first determining module 1601, configured to determine, based on a protocol, a frequency-domain resource occupied by an uplink subband used for uplink transmission in a specified downlink slot, where the specified downlink slot is used for simultaneous uplink transmission and downlink transmission.

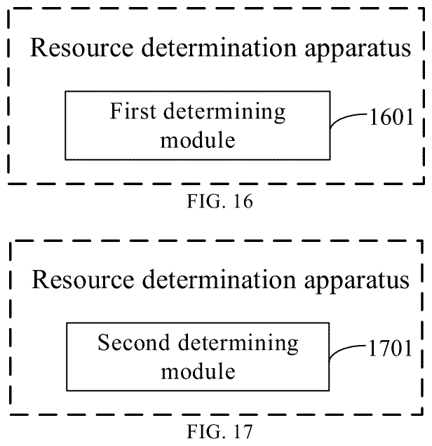

Referring to FIG. 17, FIG. 17 is a block diagram of a resource determination apparatus according to an example embodiment. The apparatus is applied to a base station, and includes:

a second determining module 1701, configured to determine, based on a protocol, a frequency-domain resource occupied by an uplink subband used for uplink transmission in a specified downlink slot, where the specified downlink slot is used for simultaneous uplink transmission and downlink transmission.

Since the apparatus embodiments basically correspond to the method embodiments, similar contents can be referred from description in the method embodiments. The apparatus embodiments described above are merely illustrative, where the unit described above as separate components may or may not be physically separate, and the components displayed as the unit may or may not be physical units, that is, may be located in one place, or may be distributed on multiple network units. Part or all of the modules may be selected according to actual needs to achieve the purpose of the present disclosure. Those skilled in the art can understand and implement the present disclosure without making any creative efforts.

Correspondingly, the present disclosure further provides a computer-readable storage medium, where the storage medium stores a computer program, and the computer program is used to perform the resource determination method for the terminal.

Correspondingly, the present disclosure further provides a computer-readable storage medium, where the storage medium stores a computer program, and the computer program is used to perform any one of the resource determination method for the base station.

Correspondingly, the present disclosure further provides a resource determination device, including:
a processor; and
a memory for storing a processor-executable instruction;
where the processor is configured to perform any one of the resource determination method in the terminal side.

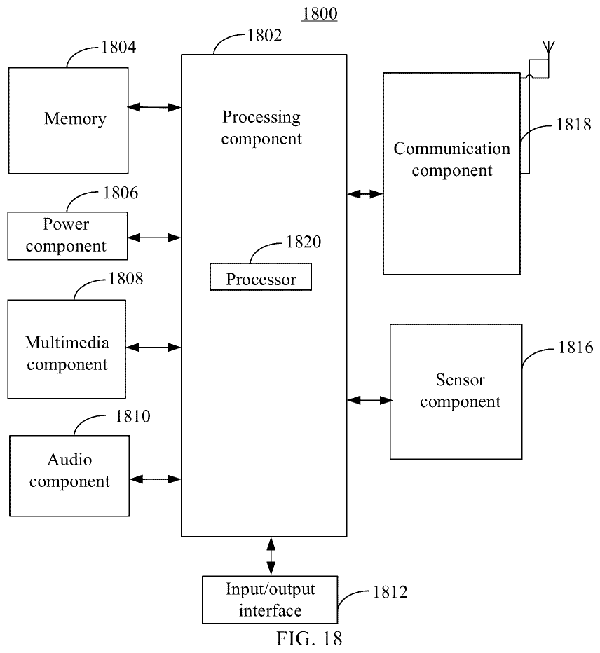

FIG. 18 is a block diagram of an electronic device 1800 according to an example embodiment. For example, the electronic device 1800 may be a terminal such as a mobile phone, a tablet computer, an e-book reader, a multimedia playing device, a wearable device, an in-vehicle terminal, an iPad, or a smart television.

Referring to FIG. 18, the electronic device 1800 may include one or more of following components: a processing component 1802, a memory 1804, a power component 1806, a multimedia component 1808, an audio component 1810, an input/output (I/O) interface 1812, a sensor component 1816, and a communication component 1818.

The processing component 1802 generally controls overall operations of the electronic device 1800, such as operations associated with display, telephone calls, data communications, camera operations, and recording operations. The processing component 1802 may include one or more processors 1820 to execute instructions to perform all or part of the steps of the resource determination method described above. In addition, the processing component 1802 may include one or more modules to facilitate interaction between the processing component 1802 and other components. For example, the processing component 1802 may include a multimedia module to facilitate interaction between the multimedia component 1808 and the processing component 1802. For another example, the processing component 1802 may read an executable instruction from a memory, to implement steps of the resource determination method provided in the above embodiments.

The memory 1804 is configured to store various types of data to support operations on the electronic device 1800. Examples of such data include instructions for any application or method operating on the electronic device 1800, contact data, phonebook data, messages, pictures, videos, and the like. The memory 1804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 1806 provides power for various components of the electronic device 1800. The power component 1806 may include a power management system, one or more power sources, and other components associated with generating, managing, and distributing power for the electronic device 1800.

The multimedia component 1808 includes a display screen providing an output interface between the electronic device 1800 and a user. In some embodiments, the multimedia component 1808 includes a front camera and/or a rear camera. When the electronic device 1800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 1810 is configured to output and/or input audio signals. For example, the audio component 1810 includes a microphone (MIC) configured to receive an external audio signal when the electronic device 1800 is in an operation mode, such as a call mode, a recording mode, and a voice recognition mode. The received audio signal may be further stored in the memory 1804 or transmitted via the communication component 1818. In some embodiments, the audio component 1810 further includes a speaker configured to output an audio signal.

The I/O interface 1812 provides an interface between the processing component 1802 and peripheral interface modules, such as keyboards, click wheels, buttons, etc. These buttons may include, but are not limited to, home buttons, volume buttons, start buttons, and lock buttons.

The sensor component 1816 includes one or more sensors for providing status assessments of various aspects of the electronic device 1800. For example, the sensor component 1816 may detect an open/closed state of the electronic device 1800, relative positioning of components (for example, a display and a keypad of the electronic device 1800), a position change of the electronic device 1800 or a component of the electronic device 1800, a presence or absence of user contact with the electronic device 1800, an orientation or acceleration/deceleration of the electronic device 1800, and a temperature change of the electronic device 1800. The sensor component 1816 may include a proximity sensor configured to detect, without any physical contact, the presence of nearby objects. The sensor component 1816 may also include a light sensor, such as a CMOS (Complementary Metal-Oxide-Semiconductor) or CCD (Charge Coupled Device) image sensor, for use in imaging applications. In some embodiments, the sensor component 1816 may further include an acceleration sensor, a gyroscope sensor, a magnetic sensor, a pressure sensor, or a temperature sensor.

The communication component 1818 is configured to facilitate wired or wireless communication between the electronic device 1800 and other devices. The electronic device 1800 may access a wireless network based on a communication standard, such as Wi-Fi, 2G, 3G, 4G, 5G, or 6G, or a combination thereof. In an example embodiment, the communication component 1818 receives a broadcast signal or broadcast related information from an external broadcast management system via a broadcast channel. In an example embodiment, the communication component 1818 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the electronic device 1800 may be implemented by one or more application specific integrated circuit (ASIC), digital signal processor (DSPs), digital signal processing device (DSPD), programmable logic device (PLD), field programmable gate array (FPGA), controller, micro-controller, microprocessor, or other electronic component, and is configured to perform the above resource determination method.

In an example embodiment, a non-transitory machine-readable storage medium is further included, such as the memory 1804 including an instruction, where the instruction can be executed by the processor 1820 of the electronic device 1800, so as to perform the resource determination method described above. For example, the non-transitory computer-readable storage medium may be a ROM (read-only memory), a RAM (random access memory), CD-ROM (compact disc read-only memory), magnetic tape, floppy disk, optical data storage device, or the like.

Correspondingly, the present disclosure further provides a resource determination device, including:
a processor; and
a memory for storing a processor-executable instruction;
where the processor is configured to perform any one of the resource determination method in the base station side.

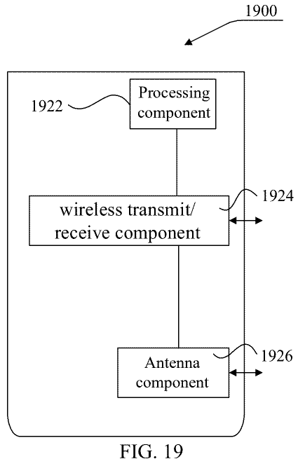

As shown in FIG. 19, FIG. 19 is a schematic structural diagram of a device 1900 according to an example embodiment. The device 1900 may be provided as a base station. Referring to FIG. 19, the device 1900 includes a processing component 1922, a wireless transmit/receive component 1924, an antenna component 1926, and a signal processing part specific to a wireless interface, and the processing component 1922 may further include at least one processor.

A processor in the processing component 1922 may be configured to perform the resource determination method described in any one of the above.

Other embodiments of the disclosure will be readily apparent to those skilled in the art upon consideration of the specification and practice of the present disclosure disclosed herein. The present disclosure is intended to cover any variations, uses, or adaptations of the present disclosure that follow the general principles of the present disclosure and include common knowledge or conventional technical means in the art not disclosed in the present disclosure. The specification and embodiments are to be regarded as example only, and the true scope and spirit of the present disclosure are indicated by the following claims.

It should be understood that the present disclosure is not limited to the precise structures already described above and shown in the accompanying drawings, and various modifications and changes may be made without departing from the scope thereof. The scope of the present disclosure is limited only by the appended claims.

1. A method for resource determination, performed by a terminal, the method comprising:
determining based on a protocol, a frequency-domain resource occupied by an uplink subband used for uplink transmission in a specified downlink slot, wherein the specified downlink slot is used for simultaneous uplink transmission and downlink transmission.

2. The method according to claim 1, wherein the protocol indicates to determine resource blocks (RB) occupied by the uplink subband based on RBs occupied by an uplink bandwidth part (BWP) in an uplink slot;
determining, based on the protocol, the frequency-domain resource occupied by the uplink subband used for uplink transmission in the specified downlink slot comprises:
determining that the RBs occupied by the uplink subband are same as the RBs occupied by the uplink BWP.

3. The method according to claim 1, wherein the protocol indicates to determine a number of resource blocks (RBs) occupied by the uplink subband based on a number of RBs occupied by an uplink bandwidth part (BWP) in an uplink slot, and to determine the RBs occupied by the uplink subband based on a reference RB;
determining, based on the protocol, the frequency-domain resource occupied by the uplink subband used for uplink transmission in the specified downlink slot comprises:
determining that the uplink subband comprises a specified number of consecutive RBs with the reference RB being a start RB or an end RB; wherein the specified number is same as the number of RBs occupied by the uplink BWP.

4. The method according to claim 3, wherein the reference RB comprises:
an RB with a minimum index value or a maximum index value in RBs occupied by a downlink BWP; or,
an RB with a minimum index value in RBs occupied by a first control resource set (CORESET) for transmitting downlink control information (DCI); wherein a number of the first CORESET is one or more; or,
an RB with a minimum index value in RBs occupied by a second CORESET for transmitting a common search space (CSS).

5. The method according to claim 4, wherein the first CORESET is a CORESET used for physical downlink control channel (PDCCH) transmission in the specified downlink slot, or the first CORESET is a CORESET used for PDCCH transmission in another downlink slot;
the second CORESET is a CORESET used for PDCCH transmission in the specified downlink slot, or the second CORESET is a CORESET used for PDCCH transmission in another downlink slot.

6. The method according to claim 2, wherein the uplink BWP belongs to an activated BWP.

7. The method according to claim 2, wherein the RBs occupied by the uplink subband is located in a range of RBs occupied by an activated downlink BWP; or,
the RBs occupied by the uplink subband comprise at least one RB located outside a range of RBs occupied by an activated downlink BWP.

8. The method according to claim 1, wherein the method further comprises at least one of:
determining RBs occupied by a physical uplink shared channel (PUSCH) in the frequency-domain resource occupied by the uplink subband based on information in a frequency-domain resource allocation information field comprised in received downlink control information (DCI);
determining RBs occupied by a PUSCH in the frequency-domain resource occupied by the uplink subband based on first resource indication information comprised in received first radio resource control (RRC) signaling; or
determining RBs occupied by a physical uplink control channel (PUCCH) and an uplink reference signal respectively in the frequency-domain resource occupied by the uplink subband based on second resource indication information comprised in received second RRC signaling.

9. A method, for resource determination performed by a base station, the method comprising:
determining, based on a protocol, a frequency-domain resource occupied by an uplink subband used for uplink transmission in a specified downlink slot, wherein the specified downlink slot is used for simultaneous uplink transmission and downlink transmission.

10. The method according to claim 9, wherein the protocol indicates to determine resource blocks (RBs) occupied by the uplink subband based on RBs occupied by an uplink bandwidth part (BWP) in an uplink slot;
determining, based on the protocol, the frequency-domain resource occupied by the uplink subband used for uplink transmission in the specified downlink slot comprises:
determining that the RBs occupied by the uplink subband is same as the RBs occupied by the uplink BWP.

11. The method according to claim 9, wherein the protocol indicates to determine a number of resource blocks (RBs) occupied by the uplink subband based on a number of RBs occupied by an uplink bandwidth part (BWP) in an uplink slot, and to determine RBs occupied by the uplink subband based on a reference RB;
determining, based on the protocol, the frequency-domain resource occupied by the uplink subband used for uplink transmission in the specified downlink slot comprises:
determining that the uplink subband comprises a specified number of consecutive RBs with the reference RB being a start RB or an end RB; wherein the specified number is same as the number of RBs occupied by the uplink BWP.

12. The method according to claim 11, wherein the reference RB comprises:
an RB with a minimum index value or a maximum index value in RBs occupied by a downlink BWP; or,
an RB with a minimum index value in RBs occupied by a first control resource set (CORESET) for transmitting downlink control information (DCI); wherein a number of the first CORESET is one or more; or,
an RB with a minimum index value in RBs occupied by a second CORESET for transmitting a common search space (CSS).

13. The method according to claim 12, wherein the first CORESET is a CORESET used for physical downlink control channel (PDCCH) transmission in the specified downlink slot, or the first CORESET is a CORESET used for PDCCH transmission in another downlink slot;
the second CORESET is a CORESET used for PDCCH transmission in the specified downlink slot, or the second CORESET is a CORESET used for PDCCH transmission in another downlink slot.

14. The method according to claim 11, wherein the uplink BWP belongs to an activated BWP.

15. The method according to claim 11, wherein the RBs occupied by the uplink subband is located in a range of RBs occupied by an activated downlink BWP; or,
the RBs occupied by the uplink subband comprise at least one RB located outside a range of RBs occupied by an activated downlink BWP.

16. The method according to claim 9, wherein the method further comprises at least one of:
sending downlink control information (DCI) to a terminal; wherein a frequency-domain resource allocation information field is used by the terminal to determine RBs occupied by a physical uplink shared channel (PUSCH) in the frequency-domain resource occupied by the uplink subband;
sending first radio resource control (RRC) signaling comprising first resource indication information to the terminal; wherein the first resource indication information is used by the terminal to determine RBs occupied by the PUSCH in the frequency-domain resource occupied by the uplink subband; or
sending second RRC signaling comprising second resource indication information to the terminal; wherein the second resource indication information is used by the terminal to determine RBs occupied by a physical uplink control channel (PUCCH) and an uplink reference signal respectively in the frequency-domain resource occupied by the uplink subband.

17. A resource determination apparatus of a terminal, comprising:
one or more processors; and
a memory for storing a processor-executable instruction;
wherein the one or more processors are collectively configured to:
determine, based on a protocol, a frequency-domain resource occupied by an uplink subband used for uplink transmission in a specified downlink slot, wherein the specified downlink slot is used for simultaneous uplink transmission and downlink transmission.

18. A resource determination apparatus of, applied to athe base station, comprising:
one or more processors; and
a memory for storing a processor-executable instruction;
wherein the one or more processors are collectively configured to perform the resource determination method according to claim 9.

19. A non-transitory computer-readable storage medium storing a computer program, the computer program when executed by one or more processors cause the terminal to perform the method according to claim 1.

20. A non-transitory computer-readable storage medium storing a computer program, and computer program when executed by one or more processors cause the base station to perform the method according to claim 9.

21.-22. (canceled)
